(19) United States
(12) Patent Application Publication
(10) Pub. No.: US 2003/0188318 A1
(43) Pub. Date: Oct. 2, 2003

(54) IP-based video-on-demand system with anti-piracy capabilities

(76) Inventors: William J. Liew, Montville, NJ (US); Chunyan Liu, Montville, NJ (US)

Correspondence Address: Chunyan Tricia Liu, 12 Mountain Ave, Montville, NJ, 07045, US

(21) Appl. No.: 10/112,234

(22) Filed: Mar. 28, 2002

(51) Int. Cl. H04N 7/16; H04N 7/173; G06F 15/16

(52) U.S. Cl. 725/93; 725/1; 709/219; 725/25

(57) ABSTRACT

An IP-based video-on-demand (VOD) system with anti-piracy capabilities. The invented system comprises at least one monitoring server and at least one billing server. The monitoring server comprises a data source monitor, a bandwidth monitor and a threshold comparator. The billing server comprises a normal pricing function and an alternative pricing function. The source of the data packets received by a client is monitored by the monitoring server. If the data packets come an unauthorized file source and the bandwidth between the client and the unauthorized file source is large, the software programs in the monitoring server and the billing generate a higher price for the client to discourage the client from downloading movie files from the authorized file source which is possibly a movie piracy website.

### BACKGROUND OF THE INVENTION

This invention relates to an Internet-protocol-based (IP-based) video-on-demand (VOD) system, and particularly to the means and steps of measuring average bandwidth consumption in a given period and using the average bandwidth consumption information for billing to prevent IP-based movie piracy.

VOD services are becoming more and more popular in US and other parts of the world. Currently there are two kinds of VOD technologies: Internet-protocol (IP) based VOD technologies and non-IP-based VOD technologies.

The IP-based VOD has a number of advantages over the non-IP-based VOD, including (1) seamless integration with existing huge IP-transmission networks (such as optical IP network) and IP-access networks (such as ADSL, wireless Internet), (2) seamless integration with other IP-based services such as web surfing, voice-over-IP, IP video phone, instant messaging, eCommerce, et al.

On the other hand, the IP-based VOD is also facing a serious challenge: Internet video piracy. The Internet video piracy issue has become so serious that the US movie studios refuse to work with the IP technology industry to have a fast launch of the IP-base VOD services and as a result the US law makers have stepped in to intervene the matter (Congress demands copy protection solution, Fri Mar. 1, 2002 by Mike Snider USA TODAY; Tech Execs Tout Talk Over Government Intervention, Thu Feb. 28, 2002 By Pamela McClintock, Yahoo News).

There exist a number of anti-piracy methods for video services other than the IP-based VOD, such as conventional analog television (TV), video cassette players (VCR). U.S. Pat. No. 3,963,865 by Songer and U.S. Pat. No. 5,243,411 by Shirochi et al disclosed methods by manipulating analog video signals to prevent illegal copying of video programs from TV or VCR tapes. U.S. Pat. No. 6,018,374 by Wrobleski disclosed a method to prevent using video camcorder to record projected images in theaters. These methods cannot be applied to the IP-based VOD since the IP-based VOD uses digital IP data other than the analog signals involved in those prior arts.

Another way of preventing video piracy is to use encryption. U.S. Pat. No. 6,005,940 by Kulinets disclosed a method to encrypt video data to prevent illegal copying of digital video data. However, any encryption algorithms are subject to hackers' attacks. That is, sophisticated hackers can always find solutions to crack encryption algorithms and decrypt video programs (such as movies) and make them available for piracy on the Internet and other piracy media.

An object of this invention is to design methods for an IP-based VOD system providing the capabilities of fighting the Internet piracy.

Another object of this invention is to design an IP-based VOD system which combines data flow monitoring functions and billing functions to provide the capabilities of fighting the Internet piracy.

### SUMMARY OF THE INVENTION

The goal of this invention is to design methods for an IP-based VOD system providing the capabilities of fighting the Internet piracy.

The VOD system in one embodiment of this invention comprises at least one monitoring server, at least one billing server, a plurality of clients, at least one authorized video file server, at least one VOD server and at least one unauthorized file source. Each monitoring server comprises a data source monitor, a bandwidth monitor and a threshold comparator. Each billing server comprises a normal pricing function and an alternative pricing function.

The authorized video file server, VOD server, unauthorized file source are connected to the Internet. The clients, monitoring server and billing server are connected to the Internet through a modem (or router, switch, hub).

In one embodiment of the invention, the monitoring server is a software program running in a hardware computer server. And the billing server is also a software program running in a hardware computer server.

For each client, the data source monitor in the monitoring server monitors the source of the data packets to check if the data packets come from the authorized video file server or the unauthorized file source. If it is found that the data packets come from the authorized video file server, then the software program goes to the normal pricing function. If it is found that the data packets come from the unauthorized file source, then the bandwidth monitor measures the average bandwidth (data rate) between the client and the unauthorized file source within a given time interval. Then the threshold comparator compares the measured average bandwidth to a given threshold. If the measured average bandwidth is greater than or equal to the threshold, then the software program goes to the alternative pricing function of the billing server. If the measured average bandwidth is smaller than the threshold, the software program goes to the normal pricing function of the billing server. The alternative pricing function generates a higher price than the normal pricing function does.

With the design disclosed in this invention, the client is charged a normal and lower price by the billing server when he/she goes to an authorized video file server for VOD services, or when he/she goes to a low data rate file source such as a non-video news website, a chat room, or a music site. On the other hand, if he/she goes to an unauthorized high bandwidth file source, usually a high-quality video file source such as a video piracy website, he/she will be charged a higher price by the billing server. This design discourages a client from going to an unauthorized high bandwidth file source such as a video piracy website and provides an effective way of video anti-piracy method.

### BRIEF DESCRIPTION OF THE DRAWINGS

FIG. 1 is a schematic diagram illustrating one embodiment of the IP-based VOD system with anti-piracy capabilities.

FIG. 2 illustrates a logic flow chart of the software program in the IP-based VOD system implementing the anti-piracy functions.

### DETAILED DESCRIPTION

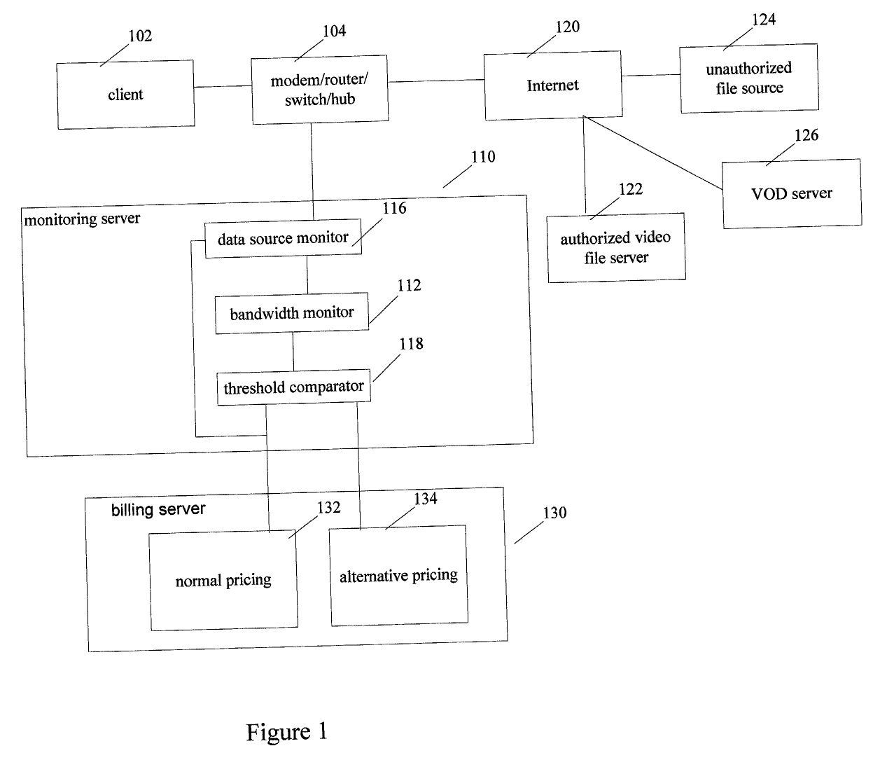

Referring to FIG. 1, the VOD system in one embodiment of this invention comprises at least one monitoring server 110, at least one billing server 130, a plurality of clients 102, at least one authorized video file server 122, at least one VOD server 126 and at least one unauthorized file source 124. Each monitoring server 110 comprises a data source monitor 116, a bandwidth monitor 112 and a threshold comparator 118. Each billing server 130 comprises a normal pricing function 132 and an alternative pricing function 134.

The authorized video file server 122, VOD server 126, and unauthorized file source 124 are connected to the Internet 120. The clients 102, monitoring server 110 and billing server 130 are connected to the Internet 120 through a modem (or router, switch, hub) 104.

In one embodiment of the invention, the monitoring server 110 is a software program residing in a general-purpose computer hardware server, such as an IBM hardware server or a Dell hardware server both running a Linux operating system. The billing server 130 is also a software program residing in a general-purpose computer hardware server. The monitoring server and the billing server could reside in the same hardware server, or in different hardware servers.

The client 102 is a hardware personnel computer (PC), a set-top-box (STB) connected to a TV set, a PDA or a wireless device.

In one embodiment of the monitoring server 110, the data source monitor 116 and the bandwidth monitor 112 are software functions (or software modules, blocks, et al) with interfaces with external hardware/software devices including the modem (or router, switch, hub) 104. The threshold comparator 118 is a software function (or a software module, block, et al).

In one embodiment of the billing server 130, the billing server 130 is a software program with a normal pricing function (or a software module, block, et al) 132 and an alternative pricing function (or a software module, block, et al) 134.

For each client 102, the data source monitor 116 in the monitoring server 110 monitors the source of the data packets to check if the data packets come from the authorized video file server 122 or the unauthorized file source 124. If it is found that the data packets come from the authorized video file server 122, then the software program goes to the normal pricing function 132. If it is found that the data packets come from the unauthorized file source 124, then the bandwidth monitor 112 measures the average bandwidth (data rate) between the client 102 and the unauthorized file source 124 within a given time interval T. Then the threshold comparator 118 compares the measured average bandwidth to a given threshold B. If the measured average bandwidth is greater than or equal to the threshold B, then the software program goes to the alternative pricing function 134 of the billing server 130. If the measured average bandwidth is smaller than the threshold B, the software program goes to the normal pricing function 132 of the billing server 130. The alternative pricing function 134 generates a higher price than the normal pricing function 132 does.

The VOD server 126, the authorized video file server 122, the monitoring server 110 and the billing server 130 together provide VOD functions for the client 102 with anti-piracy capabilities. The anti-piracy capabilities are implemented by using the software programs in the monitoring server 110 and the billing server 130 to monitor the data source and the average bandwidth and generate different pricing for the different data sources and the different average bandwidths.

In the VOD system disclosed in this invention, the anti-piracy capabilities are implemented as follows. It is assumed that the unauthorized file source 124 is a piracy movie website. If the client 102 receives the video data packets from the authorized video file server 122, the client is then charged the normal price, for example, a flat monthly access fee of US$100 per month, plus possibly video content subscription fee (e.g. US$4 per movie). On the other hand, if the client 102 receives the video data packets from the movie piracy website 124, the data rate (bandwidth) between the client 102 and the movie piracy website 124 is generally much greater than, e.g., 150 kilo bits per second (kbps) for an acceptable video and audio quality. If the threshold B is set to, e.g., 150 kbps, the client 102 will be charged a higher price by using the software programs disclosed in this invention, for example, an extra US$10 per hour in addition to the flat monthly access fee of US$100 per month. Compared to a high quality movie rental with the cost of US$4 per movie, the extra US$10 per hour charge will effectively discourage the client 102 from going to the movie piracy website to download movies.

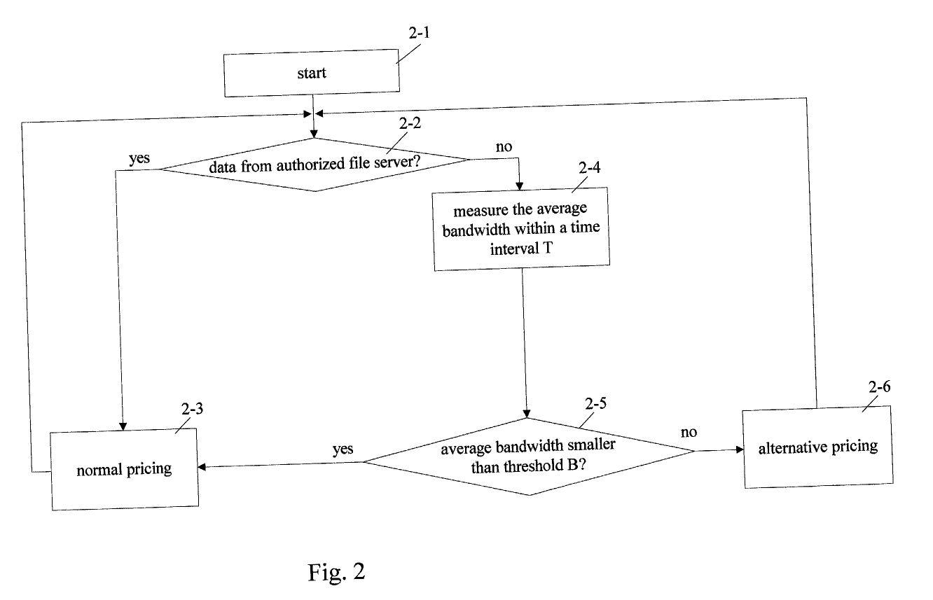

FIG. 2 illustrates a logic flow chart of software programs residing inside the monitoring server 110 and the billing server 130 which monitor the data source, measure the average bandwidth and generate different pricing for the different data sources and the different average bandwidths. At the initial step 2-1 the software programs start and then proceed to step 2-2. Then at step 2-2 it is checked if the data received by the client 102 come from the authorized video file server 122. If the data received by the client 102 come from the authorized video file server 122, the software programs go to step 2-3 for the normal pricing function. If the data received by the client 102 come from the unauthorized file source 124, the programs go to step 2-4 to measure the average bandwidth between the client 102 and the unauthorized file source 124 within a time interval T, then go to step 2-5 to compare the measured average bandwidth to a threshold B. At step 2-5, if the measured average bandwidth is not smaller than the threshold B, the programs go to step 2-6 for the alternative pricing function (generally generating a higher price), and then go to step 2-2 to continue the programs. If the measured average bandwidth is smaller than the threshold B, the programs go to step 2-3 for the normal pricing function.

The steps 2-2 to 2-6 in FIG. 2 implement the VOD system with anti-piracy capabilities. With the software programs disclosed in this invention, the data sources are monitored and the average bandwidth is measured and the different pricing is generated for the different data sources and the different average bandwidths. These methods effectively discourage the client from going to a movie piracy website to download movies by charging the client higher prices if he/she chooses to download from the movie piracy website.

While considerable emphasis has been herein on the preferred embodiment illustrated and described hereinabove, it will be appreciated that other embodiments of the invention can be made and that changes can be made in the preferred embodiment without departing from the principals of the present invention. Accordingly, it is to be distinctly understood that the foregoing descriptive matter is to be interpreted merely as illustrative of the invention and not as a limitation.

1. An IP-based VOD system comprising:
an Internet,
at least one client connected to said Internet,
at least one monitoring server connected to said Internet and comprising a data source monitor, a bandwidth monitor, a threshold comparator,
at least one billing server coupled with said monitoring server and comprising a normal pricing function and an alternative pricing function,
at least one authorized video file server connected to said Internet,
at least one VOD server connected to said Internet,
at least one unauthorized file source connected to said Internet,
wherein said monitoring server monitors data going to said client, said client downloads authorized video files from said authorized video file server, said VOD server administers and controls VOD functions for said client downloading said authorized video files, said client may download unauthorized files from said unauthorized file source and said billing server generates billing information for said client according to output from said monitoring server.

2. The IP-based VOD system as defined in claim 1 wherein:
said data source monitor monitors the source of data packets received by said client.

3. The IP-based VOD system as defined in claim 2 wherein:
said normal pricing function is used if said data packets come from said authorized video file server.

4. The IP-based VOD system as defined in claim 2 wherein:
if said data packets come from said unauthorized file source,
(1) said bandwidth monitor measures the average bandwidth between said client and said unauthorized file source within a time interval and generates a measured average bandwidth,
(2) said measured average bandwidth is compared to a threshold,
(3) said normal pricing function is used if said measured average bandwidth is smaller than said threshold,
(4) said alternative pricing function is used if said measured average bandwidth is not smaller than said threshold.

5. The IP-based VOD system as defined in claim 4 wherein:
said alternative pricing function generates a higher price than said normal pricing function generates for said client.

6. The IP-based VOD system as defined in claim 1 wherein:
said monitoring server and said billing server comprise software programs implementing a process comprising the steps of:
(6-1) starting said software programs and then proceeding to step 6-2,
(6-2) checking the source of data packets received by said client, and proceeding to step 6-3 if said data packets come from said authorized video file server, and proceeding to step 6-4 if said data packets come from said unauthorized file source,
(6-3) using said normal pricing function to compute the price for said client, and going to back to step 6-2,
(6-4) measuring the average bandwidth between said client and said unauthorized file source within a time interval and generating a measured average bandwidth, and proceeding to step 6-5,
(6-5) using said alternative pricing function to compute the price for said client, and going to back to step 6-2.
